(19) United States
(12) Patent Application Publication
(10) Pub. No.: US 2004/0056000 A1
(43) Pub. Date: Mar. 25, 2004

(54) SURFACE PROCESSING METHOD FOR A MOLDED METAL HOUSING

(76) Inventors: C.Y. Hong, Taipei Hsien (TW); Chu-Chia Tsai, Taipei Hsien (TW)

Correspondence Address: NAIPO (NORTH AMERICA INTERNATIONAL PATENT OFFICE), P.O. BOX 506, MERRIFIELD, VA, 22116, US

(21) Appl. No.: 10/248,278

(22) Filed: Jan. 6, 2003

(30) Foreign Application Priority Data
Sep. 20, 2002 (TW) 091121691

(51) Int. Cl. C23F 1/00; B44C 1/22; C25F 3/00; C03C 15/00; C03C 25/68

(52) U.S. Cl. 216/100

(57) ABSTRACT

A surface processing method for forming a predetermined pattern on a molded metal housing includes forming an isolation layer related to the predetermined pattern onto the surface of the molded metal housing and etching the surface of the molded metal sheet. The isolation layer is used for defining whether the surface of the molded metal sheet covered by the isolation layer is etched or not.

### BACKGROUND OF THE INVENTION

1. Field of the Invention

The invention relates to a surface processing method for a molded metal housing, and more particularly, to a surface processing method for forming patterns on a molded metal housing.

2. Description of the Prior Art

The sale of products is improved by labeling a reasonable price tag and by emphasizing spectacular functions for the products. In addition, an outward appearance of the product will greatly distinguish this product from other similar products. Therefore, the consumers generally like to have the products having distinctive outward appearances. With regard to the metal housing such as the housing of the laptop computer or the housing of electronic products, the metal housing is fabricated by the die-casting process, the stamping process, or injection molding process so that a special shape will be made. Generally speaking, an anodizing process is used to generate a surface coating layer for the metal housing, and makes a surface of the metal housing brilliant. A sandblasting process is also adopted to sculpt or to polish the surface of the metal housing. However, it is hard for the sandblasting process to form a three-dimensional (3D) pattern on the surface. With regard to the plastic housing, the predetermined three-dimensional pattern is formed on a mold in advance for producing the plastic housing with the predetermined three-dimensional pattern later. It is well known that a single mold is only capable of forming a corresponding pattern. But, identical products sometimes require different outward appearances to meet preferences of different users. For example, the housings of the laptop computers having the same model number vary to provide consumers with different choices. In other words, the laptop computers with different housing designs have superior competitiveness in the market. The manufacturers, therefore, have to repeatedly design the mold to provide different patterns on the plastic housings. It is obvious that the plastic housing is not so firm and solid as the metal housing is. Therefore, the metal housing is widely used to protect the fragile devices inside. Among the prior art housings, a printing method is applied to print patterns with different colors onto the metal housing and the plastic housing. The printed pattern, however, is easily wiped off by frequent touches or an occasional contact. For the product requiring a shining outlook on the metal housing, the prior art printing method is not suitable to form the brilliant surface, and is not capable of providing the product with a three-dimensional visual effect and a three-dimensional tactile sense, not to mention the expensive processing cost.

### SUMMARY OF INVENTION

It is therefore a primary objective of the claimed invention to provide a surface processing method for forming a predetermined three-dimensional pattern through etching surface of a metal housing to solve the above-mentioned problem.

According to the claimed invention, a surface processing method for forming a predetermined pattern on a metal housing is provided. The metal housing is molded into a predetermined shape in advance. The surface processing method includes covering a surface of the metal housing with an isolation layer corresponding to the predetermined pattern, soaking the metal housing in an etching solution for etching parts of the surface of the metal housing which are not covered by the isolation layer, and removing the isolation layer and the etching solution from the surface of the metal housing.

The claimed method only needs to change allocation of the isolation layer located on the surface of the metal housing for altering patterns presented on the surface of the metal housing. In other words, the surface of the metal housing is engraved by the etching process without rebuilding the mold that is used to generate the metal housing. The production cost is lowered, and the yield of the metal housings with different patterns is increased.

These and other objectives of the present invention will no doubt become obvious to those of ordinary skill in the art after reading the following detailed description of the preferred embodiment that is illustrated in the various figures and drawings.

### BRIEF DESCRIPTION OF DRAWINGS

FIG. 1 is a flow chart of a method for forming a pattern on a metal housing according to the present invention.

FIG. 2 to FIG. 5 are diagrams showing operation of the preferred embodiment according to the present invention.

### DETAILED DESCRIPTION

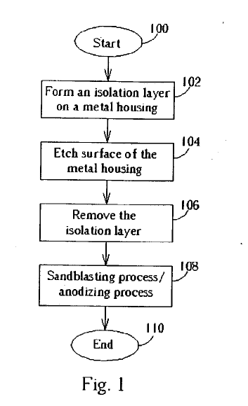

Please refer to FIG. 1, which is a flow chart of the method for forming a pattern on a metal housing according to the present invention. The method includes the following steps.

Step 100:Start;

Step 102:

Form an isolation layer corresponding to a predetermined pattern on surface of the metal housing;

Step 104:

Etch parts of the surface of the metal housing which are not covered by the isolation layer;

Step 106:Remove the isolation layer from the surface of the metal housing;

Step 108:

Perform a sandblasting process and an anodizing process on the metal housing; and

Step 110:End.

The surface processing method according to the present invention is applied on a metal housing, which has been molded into a predetermined shape according to a prior art method such as the stamping process, for forming a three-dimensional pattern on the surface of the metal housing, and provides the surface of the metal housing with a predetermined brilliant metallic luster. This kind of metal housing is suitable for a laptop computer, a PDA, a cellular phone, etc.

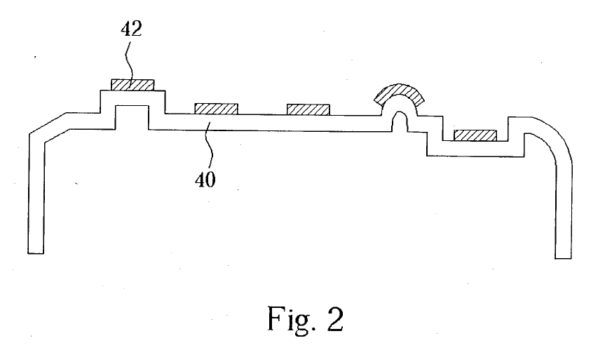

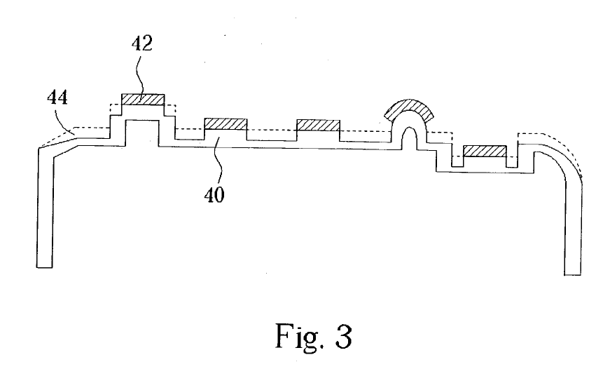

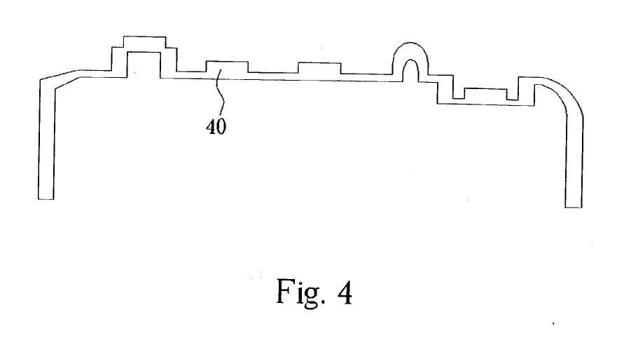

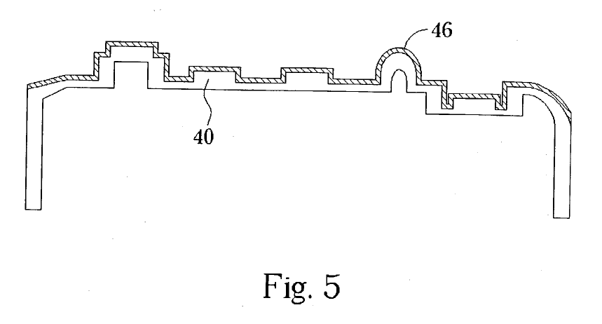

Operation of the surface processing method according to the present invention is described as follows. Please refer to FIG. 2 to FIG. 5, which are diagrams showing operation of the preferred embodiment according to the present invention. A metal housing 40 is first manufactured according to a prior art method such as the die-casting process, the stamping process, or injection molding. In the preferred embodiment, the metal housing 40 generally is composed of alloys such as aluminum alloys or magnesium alloys. An isolation layer 42, which corresponds to a predetermined pattern, is then formed on a predetermined location of the surface of the metal housing 40 (step 102). Generally speaking, the isolation layer 42 comprises organic compounds such as coal tar or printing ink for covering and protecting the surface of the metal housing 40 so that parts of the surface covered by the isolation layer 42 will not react with an inorganic solution. An etching solution such as ferric chloride (FeCl₃), hydrogen peroxide (H₂O₂), nitric acid (HNO₃), or hydrofluoric acid (HF) is used to etch the metal housing 40 (step 104). The etching solution reacts with oxides contained in the metal housing 40. Therefore, The oxides are removed from the surface of the metal housing 40 after the chemical reaction, and the objective of etching the metal housing 40 is achieved. This step is capable of being performed by soaking the metal housing 40 in the etching solution. In the preferred embodiment, a mixed solution comprising the KOH solution with a concentration of 10% and the Na₃PO₄ solution with a concentration of 5% is used to be the etching solution. In addition, the mixed solution etches the metal housing 40 in an operating environment whose temperature is 45 degrees centigrade for a better etching speed to shorten the time required to etch the metal housing 40. As shown in FIG. 3, parts of the surface of the metal housing 40 without being covered by the isolation layer 42 are etched. In other words, the isolation layer 42 protects the underneath portions of the metal housing 40 from reacting with the etching solution. Clean water is then used to dilute the etching solution and finally removes the etching solution from the metal housing 40. Afterwards, an organic solution is used to remove the existing isolation layer 42 on the metal housing 40 (step 106). The operation result is shown in FIG. 7. After being etched, the metal housing 40 is capable of forming a three-dimensional pattern. A sandblasting process is applied to the metal housing 40 for polishing the surface of the metal housing 40, and then an anodizing process is used to form a metal compound membrane 46 on the surface of the metal housing 40. In other words, the metal compound membrane 46 is capable of preventing the processed surface from being oxidized later on and is capable of providing the coating surface with metallic luster.

The formation of the isolation layer mentioned in step 102 can be performed through a printing process to locate the isolation layer corresponding to a predetermined pattern on the surface of the metal housing 40. For example, if the surface of the metal housing 40 is approximately flat, a silk screen printing process is adopted. If the surface of the metal housing 40 has an abrupt transformation or a curved portion, a pad printing process is then adopted. However, many kinds of printing methods are suitable to locate the isolation layer corresponding to a predetermined pattern on the surface of the metal housing 40. For instance, the isolation layer corresponding to a predetermined pattern is first printed on an intermediary unit like a plastic membrane or an adhesive tape through the silk screen printing process. Then, the surface of the intermediary unit contacts with the surface of the metal housing 40 for transferring the isolation layer previously printed on the intermediary unit onto the surface of the metal housing 40. In the end, the intermediary unit is removed. In addition, the isolation layer can be sprayed on the surface of the metal housing to generate an irregular pattern.

Briefly summarized, the surface of the metal housing 40 is capable of having a regular pattern or an irregular pattern according to the claimed surface processing method. With regard to different housings of the same product, the position of the isolation layer 42 covering the metal housing 40 is adjustable according to different pattern designs so that the surface of the metal housing 40 is then etched to show the desired three-dimensional pattern. In the preferred embodiment, a plurality of metal housings 40 are generated via the same mold. The manufacturer only changes allocation of the isolation layer 42 to make each metal housing 40 have a specific pattern. That is, different textures are easily formed on the metal housings 40 without rebuilding the mold used to generate the metal housings 40 corresponding to the same product.

In addition, the sandblasting process in step 108 can be performed prior to locating the isolation layer (step 102). That is, before the metal housing 40 is etched, the metal housing 40 is polished by the sandblasting process. Compared with the procedure that has the etching process prior to the sandblasting process, the amended procedure that has the sandblasting process prior to the etching process can make the surface of the metal housing 40 have metallic brilliance with a more visible contrast in different portions. For example, when the sandblasting process is performed before step 102, the metallic brilliance of the etched portions and the non-etched portions generate a greater contrast after the surface has been processed by the anodizing process. However, if the sandblasting process is performed in step 108, the metallic brilliance of the etched portions and the non-etched portions generate a less obvious contrast after the anodizing process has processed the surface. Similarly, the preferred embodiment is capable of applying the sandblasting process with different polish capacities to affect the luster contrast between the etched and un-etched areas. For example, different sizes of grains are capable of respectively polishing the surface to effect extent of the smoothness of the surface.

In contrast to the prior art, the surface processing method of the claimed invention uses the silk screen printing process, the pad printing process, the intermediary unit, or the spraying process to print an isolation layer corresponding to a predetermined pattern onto the surface of the metal housing. An etching solution is then used to etch parts of the surface, which are not covered by the isolation layer. The isolation layer existing on the surface of the metal housing is also removed. Therefore, a three-dimensional pattern is formed on the surface of the metal housing. In the end, an anodizing process is performed to coat the surface of the metal housing with a metal compound membrane. The metal compound membrane can protect the surface from being gradually oxidized, and provides the surface of the metal housing with metallic luster. The claimed method only needs to change allocation of the isolation layer located on the surface of the metal housing for altering patterns presented on the surface of the metal housing. In other words, the surface of the metal housing is engraved by the etching process without rebuilding the mold that is used to generate the metal housing. The production cost is lowered, and the yield of the metal housings with different patterns is increased.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A surface processing method for forming a predetermined pattern on a metal housing, the metal housing being molded into a predetermined shape in advance, the surface processing method comprising following steps:
(a)covering a surface of the metal housing with an isolation layer corresponding to the predetermined pattern;
(b)soaking the metal housing in an etching solution for etching parts of the surface of the metal housing which are not covered by the isolation layer; and
(c)removing the isolation layer and the etching solution from the surface of the metal housing.

2. The surface processing method of claim 1 wherein the isolation layer is printing ink.

3. The surface processing method of claim 1 wherein step (a) comprises:
forming the isolation layer on the surface of the metal housing by a predetermined printing process.

4. The surface processing method of claim 3 wherein the predetermined printing process is a silk screen printing process.

5. The surface processing method of claim 3 wherein the predetermined printing process is a pad printing process.

6. The surface processing method of claim 1 wherein step (a) comprises:
spraying the isolation layer onto the surface of the metal housing.

7. The surface processing method of claim 1 wherein step (a) comprises:
printing the isolation layer on a surface of a transfer medium;
contacting the surface of the metal housing and the surface of the transfer medium which is printed by the isolation layer for transferring the isolation layer from the transfer medium to the surface of the metal housing; and
removing the transfer medium.

8. The surface processing method of claim 7 wherein the transfer medium is a plastic membrane.

9. The surface processing method of claim 1 wherein the etching solution is used for removing oxides of the metal housing.

10. The surface processing method of claim 1 wherein the etching solution comprises KOH and Na₃PO4.

11. The surface processing method of claim 1 further comprising:
performing a sandblasting process on the surface of the metal housing for smoothing the surface of the metal housing before starting step (a).

12. The surface processing method of claim 1 further comprising:
performing a sandblasting process on the surface of the metal housing for smoothing the surface of the metal housing after finishing step (c).

13. The surface processing method of claim 1 further comprising:
performing an anodizing process on the surface of the metal housing for forming a metal compound membrane to cover the surface of the metal housing after finishing step (c).

14. The surface processing method of claim 1 wherein the metal housing comprises aluminum alloys.

15. The surface processing method of claim 1 wherein the metal housing comprises magnesium alloys.
